(19) United States
(12) Patent Application Publication
(10) Pub. No.: US 2026/0250810 A1
(43) Pub. Date: Aug. 27, 2026

(54) HIGH-MAGNETIC-INDUCTION GRAIN-ORIENTED SILICON STEEL WITH EXCELLENT SURFACE AND PREPARATION METHOD THEREFOR

(71) Applicant: SHOUGANG ZHIXIN ELECTROMAGNETIC MATERIALS (QIAN'AN) CO., LTD., Tangshan (CN)

(72) Inventors: Xianhui WANG, Tangshan (CN); Qian GAO, Tangshan (CN); Maolin SUN, Tangshan (CN); Zhiyuan HU, Tangshan (CN); Songshan ZHAO, Tangshan (CN); Liangying SI, Tangshan (CN); Jianhui TIAN, Tangshan (CN); Ruifeng LI, Tangshan (CN); Donghe SONG, Tangshan (CN); Zhijie ZHANG, Tangshan (CN); Renhao TENG, Tangshan (CN); Xianhao LI, Tangshan (CN); Pengfei ZHAO, Tangshan (CN); Jiafeng LIU, Tangshan (CN)

(73) Assignee: SHOUGANG ZHIXIN ELECTROMAGNETIC MATERIALS (QIAN'AN) CO., LTD., Tangshan, HE (CN)

(21) Appl. No.: 19/645,176

(22) Filed: Apr. 11, 2026

Related U.S. Application Data
(63) Continuation of application No. PCT/CN2024/084477, filed on Mar. 28, 2024.

(30) Foreign Application Priority Data
Apr. 6, 2023 (CN) 202310355200.8

(51) Int. Cl. C22C 38/02; C21D 6/00; C21D 8/1216; C21D 8/1244; C21D 8/1277; C21D 9/52; C22C 38/00; C22C 38/04; C22C 38/06; C22C 38/20; C23C 8/02; C23C 8/26; C23C 8/80

(52) U.S. Cl. CPC C22C 38/02; C21D 6/008; C21D 8/1222; C21D 8/1233; C21D 8/1255; C21D 8/1272; C21D 8/1283; C21D 9/52; C22C 38/001; C22C 38/002; C22C 38/008; C22C 38/04; C22C 38/06; C22C 38/20; C23C 8/02; C23C 8/26; C23C 8/80

(57) ABSTRACT

The disclosure relates to a high-magnetic-induction grain-oriented silicon steel with excellent surface and a preparation method therefor. The method comprises: obtaining a cold-rolled steel strip; performing a decarburization annealing and a nitriding treatment on the cold-rolled steel strip to form an oxide film on the surface of the cold-rolled steel strip; coating the cold-rolled steel strip, subjected to the decarburization annealing and nitriding treatment, with a separant, followed by drying; drying the cold-rolled steel strip coated with the separant and coating the same with an active agent, followed by coiling to obtain a steel coil, the active agent comprising a low-melting-point compound with a melting point ≤900° C.; and performing an annealing treatment on the steel coil to obtain a silicon steel.

### CROSS-REFERENCE TO RELATED APPLICATIONS

This is a continuation of International Application No. PCT/CN2024/084477, filed on Mar. 28, 2024, which claims priority to Chinese Patent Application No. 202310355200.8, filed on Apr. 6, 2023. The disclosures of the above-referenced applications are hereby incorporated by reference in their entireties

### TECHNICAL FIELD

The disclosure relates to the technical field of steel preparation, and in particular to a high-magnetic-induction grain-oriented silicon steel with excellent surface and preparation method therefor.

### BACKGROUND

High-magnetic-induction grain-oriented silicon steel is a core soft magnetic material for electric power construction, and has an extremely complicated manufacturing process. Manufacturing the high-magnetic-induction grain-oriented silicon steel with a low-temperature process is a main development direction, and has a manufacturing process comprising: smelting, continuous casting, slab heating, hot rolling, normalizing, cold rolling, decarburization annealing, nitriding, coating of annealing separant, high-temperature annealing, hot stretch leveling and the like. A control of forsterite bottom layer on a surface of a low-temperature heating grain-oriented silicon steel is a key technical point and difficulty, and has particularly prominent problem in a development of products towards thinner gauges.

The forsterite bottom layer is generated by a reaction between the SiO₂ film on a surface and a MgO separant during the high-temperature annealing process, has a suitable thickness of 1~1.5 μm, is an intermediate layer connecting an insulating coating and a steel substrate, and an important structural part of a product. Main functions of the forsterite bottom layer comprise ensuring a surface insulation resistance, increasing a surface tension, improving a magnetic property and the like. A defect of a superficial forsterite bottom layer can directly lead to disqualified final product, thereby reducing a yield rate.

To build a new pattern of a high-efficiency power grid, grain-oriented silicon steel products with a thinner gauge and a lower iron loss are required for support. In recent years, to improve a product performance, various enterprises have successively developed high-performance products with gauges of 0.23 mm, 0.20 mm, 0.18 mm and even thinner. As oriented products are thinned, a difficulty of controlling a forsterite bottom layer increases. Defects such as bare spots, a thin forsterite bottom layer and a color difference at an edge of a steel coil are bottlenecks restricting a mass production and quality improvement of products, and are new problems in the industry that have not been well solved in the industry, resulting in a low production qualification rate and a high production cost.

### SUMMARY

The problems of defects such as bare spots, a thin forsterite bottom layer, a color difference, an uneven forsterite bottom layer and unqualified performance at an edge of a steel coil existing in current production of thin gauge silicon steel are solved by using one or more embodiments of the disclosure.

According to a first aspect of the disclosure, a method for preparing a high-magnetic-induction grain-oriented silicon steel with excellent surface is provided, the method comprising: obtaining a cold-rolled steel strip; performing a decarburization annealing and nitriding treatment on the cold-rolled steel strip to form an oxide film on a surface of the cold-rolled steel strip; coating the cold-rolled steel strip subjected to the decarburization annealing and nitriding treatment, with a separant; drying the cold-rolled steel strip coated with the separant and coating the same with an active agent, followed by coiling to obtain a steel coil, a component of the active agent comprising a low-melting-point compound with a melting point ≤900° C.; and performing an annealing treatment on the steel coil to obtain a silicon steel.

According to a second aspect of the disclosure, a high-magnetic-induction grain-oriented silicon steel with excellent surface is provided, the silicon steel being prepared by the method for preparing the high-magnetic-induction grain-oriented silicon steel with excellent surface according to the first aspect.

### BRIEF DESCRIPTION OF DRAWINGS

The drawings, which are incorporated into and constitute a part of this specification, illustrate embodiments consistent with the disclosure, and together with the specification, serve to explain principles of the disclosure.

To more clearly illustrate technical solutions in the embodiments of the disclosure or the prior art, the drawings required for description of the embodiments or the prior art will be briefly introduced below. Obviously, for those skilled in the art, other drawings can also be obtained according to these drawings without creative labor.

FIG. 1 shows a flow chart of a method for preparing a high-magnetic-induction grain-oriented silicon steel with excellent surface according to some embodiments of the disclosure.

FIG. 2 shows a schematic structural diagram of a cold-rolled steel strip according to some embodiments of the disclosure.

FIG. 3 shows a schematic structural diagram of an equipment system according to some embodiments of the disclosure.

Reference numerals: 1, steel strip; 2, decarburization annealing and nitriding furnace; 3, separant coater; 4, drying furnace; 5, steel strip coiler; 6, active agent coater; 7, active agent.

### DETAILED DESCRIPTION

To make objectives, technical solutions and advantages of the embodiments of the disclosure clearer, the technical solutions in the embodiments of the disclosure will be clearly and completely described below in conjunction with the drawings in the embodiments of the disclosure. Obviously, the described embodiments are some embodiments, rather than all embodiments of the disclosure. All other embodiments obtained by those skilled in the art without creative labor based on the embodiments in the disclosure shall fall within a protection scope of the disclosure.

Unless otherwise specified, various raw materials, reagents, instruments and apparatus used in the disclosure can be purchased from the market or prepared by existing methods.

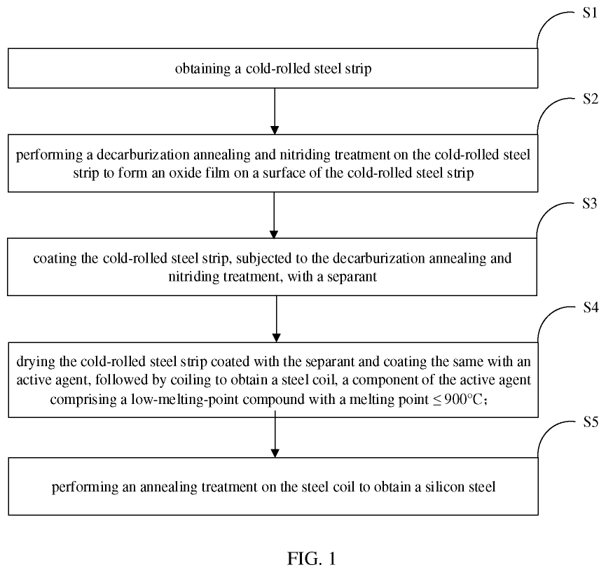

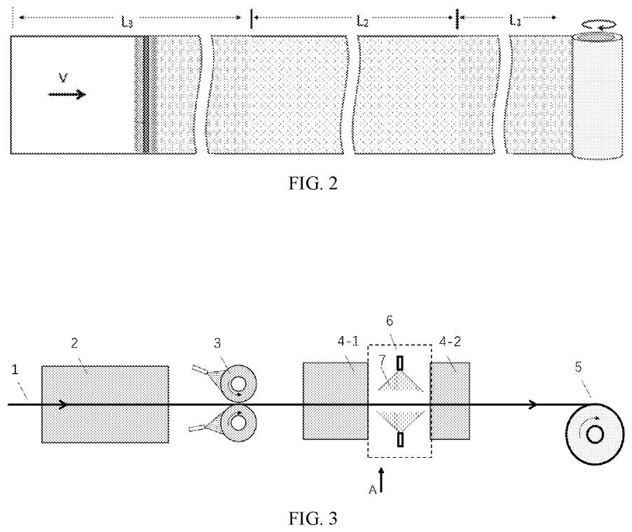

As shown in FIG. 1, the method for preparing a high-magnetic-induction grain-oriented silicon steel with excellent surface according to some embodiments of the disclosure comprises steps S1 to S5.

In Step S1: a cold-rolled steel strip is obtained.

In some embodiments, components of the cold-rolled steel strip comprise, by weight fraction: C: 0.04%~0.08%; Si: 3.0%~4.0%; Mn: 0.03%~0.22%; S: 0.005%~0.020%; Als: 0.0235%~0.0345%; N: 0.0050% 0.0130%; Sn: 0.01% 0.15%; Cr: 0.03%~0.4%; Cu: 0.01% 0.8%; and the balance being Fe and inevitable impurities. A preparation process for the cold-rolled steel strip comprises: controlling the grain-oriented silicon steel within a reasonable range through smelting, and forming a slab with a thickness of 230 mm-250 mm through continuous casting. In some embodiments, the slab is heated to a temperature range of 1080° C.~1230° C. for heat preservation, followed by hot rolling, normalizing and cold rolling.

In Step S2: a decarburization annealing and nitriding treatment are performed on the cold-rolled steel strip to form an oxide film on a surface of the cold-rolled steel strip.

In some embodiments, a thickness of the oxide film on a surface (single side) of the steel strip after the decarburization annealing is controlled to be 2.0~3.5 μm, and an atomic weight ratio of Si and Fe elements in the oxide film satisfies Fe/(Si+Fe)=0.08~0.25.

The purpose of controlling the thickness of the oxide film on a surface (single side) of the steel strip after the decarburization annealing to be 2.0~3.5 μm, and making an atomic weight ratio of Si and Fe elements in the oxide film to satisfy Fe/(Si+Fe)=0.08~0.25 is to make the oxide film formed on the surface of the steel strip have a certain reaction activity, so as to lay a foundation for a reaction of forming a good forsterite bottom layer after subsequent coating of the active agent.

In Step S3: the cold-rolled steel strip, subjected to the decarburization annealing and nitriding treatment, is coated with a separant.

In some embodiments, the separant may be selected from MgO.

In Step S4: the cold-rolled steel strip coated with the separant is dried, and is coated with an active agent, and then is coiled to obtain a steel coil, a component of the active agent comprising a low-melting-point compound with a melting point ≤900° C.

In some embodiments, a drying furnace may be configured as two independent sections, namely a drying section and a cooling section respectively. The coating of the active agent may be performed by spraying, with a droplet diameter of 10~300 μm. A spraying system for the active agent may be arranged between the drying section and the cooling section, that is, coating of the active agent is performed after drying is completed. In other embodiments, the spraying system for the active agent may also be arranged before or after the drying furnace, that is, coating of the active agent is performed before or after drying is performed.

In some embodiments, the low-melting-point compound may be selected from at least one of oxides of reactive metals, fluorides of reactive metals, chlorides of reactive metals, carbonates of reactive metals and sulfates of reactive metals. The reactive metal may be selected from at least one of Sr, Sb, Na, Mg, Zn, Ba and Ca. In some embodiments, the low-melting-point compound may be selected from SrO, SrF₂, SrCl₂, SrCO₃, SrSO₄, Sb₂O₃, SbF₃, SbCl₃, Sb₂(CO₃)₃, Sb₂(SO₄)₃, Na₂O, NaF, NaCl, Na₂CO₃, Na₂SO₄, ZnO, ZnF₂, ZnCl₂, ZnCO₃, ZnSO₄, BaO, BaF₂, BaCl₂, BaCO₃, BaSO₄, CaO, CaF₂, CaCl₂), CaCO₃, CaSO₄ and the like. A weight concentration of the low-melting-point compound in the active agent is 10%~50% and is lower than a concentration of a saturated solution; a state of the active agent may be a solution or a suspension.

In some embodiments, after coating of the active agent is completed, a period during which a surface temperature of the cold-rolled steel strip is ≥150° C. at least exists, to dry the active agent. This can be achieved by controlling a temperature of the drying furnace and a reasonable position of the spraying system. For example, when the spraying system is arranged before the drying furnace or in the middle of the drying furnace, after spraying, the drying furnace will continue to heat the steel strip to complete drying of the active agent; or when the spraying system is arranged after the drying furnace, spraying of the active agent needs to be completed before a temperature of the steel strip drops to 150° C., that is, the spraying system needs to be arranged before a point where the temperature of the steel strip drops to 150° C. In other embodiments, a heating unit may also be separately arranged to heat the steel strip after the active agent is sprayed to complete drying, in which case an installation position of the spraying system does not need to be considered.

In some embodiments, the coating of the active agent is a single-side coating or a double-side coating. In some embodiments, when the coating of the active agent is the single-side coating, the low-melting-point compound may at least contain one fluorine salt of a reactive metal or one chlorine salt of a reactive metal, and m₀≥0.2% M₀, where m₀ is a set reference spraying amount of the active agent with a unit of g/m²; M₀ is a coating amount of the separant, and a unit of M₀ is g/m². During a high-temperature annealing process, F, Cl and the like in halides react with an annealing atmosphere H₂ to generate active gases such as HCl and FeCl₂, etc., which facilitate a uniform mass transfer between layers of the steel coil.

The applicant has found a problem of surface bare spots defects caused by poor reaction capacity at a head portion and a tail portion due to uneven heating during high-temperature annealing of thin gauge products in a traditional process. Defects such as a bare spots and a color difference of the forsterite bottom layer at an edge of several turns of an outer circle of a high-magnetic-induction grain-oriented silicon steel coil belong to under-reaction defects. Therefore, the applicant intends to locally increase a spraying amount of the active agent on the steel strip, i.e., on a first section and a last section of the cold-rolled steel strip, so that a liquid or gaseous substance is formed between layers of the steel coil during a subsequent annealing treatment to accelerate mass transfer, thereby promoting a formation reaction of the forsterite bottom layer locally on the steel coil.

In some embodiments, the cold-rolled steel strip comprises a first section, a middle section and a last section, and a relationship of a length L₁ of the first section, a length L₂ of the middle section, a length L₃ of the last section and a total length L of the entire cold-rolled steel strip satisfy: L=L₁+L₂+L₃; a relationship between the length L₁ of the first section and the total length L of the entire cold-rolled steel strip satisfies: L₁=0.05L~0.3L; a relationship between the length L₃ of the last section and the total length L of the entire cold-rolled steel strip satisfies: L₃=0.1L~0.4L. Relationships among an active agent coating amount m₁ of the first section, an active agent coating amount m₂ of the middle section and an active agent coating amount m₃ of the last section satisfy: m₁≥m₂ and m₃≥m₂, respectively.

In some embodiments, a calculation formula of the active agent coating amount m₁ of the first section is:

$${m}_{1} = {a}_{1} ( 1 - \frac{vt}{{L}_{1}} ) + {m}_{0} ,$$

where m₀ is (0.1%~5%)×M₀, M₀ is a coating amount of the separant, and a unit of M₀ is g/m²;
a₁ is (0.2~1.5)×m₀;
v is a running speed of the cold-rolled steel strip, and a unit of v is m/min;
t is a coating time for the first section, and a unit of t is min;
L₁ is a length of the first section, and a unit of L₁ is m;
a calculation formula for the active agent coating amount m₂ of the middle section is:

$${m}_{2} = {m}_{0} ,$$

where m₀ is (0.1%~5%)×M₀, M₀ is a coating amount of the separant, and a unit of M₀ is g/m²;
a calculation formula for the active agent coating amount m₃ of the last section is:

$${m}_{3} = {a}_{3} \cdot \frac{vt}{{L}_{3}} + {m}_{0} ,$$

where m₀ is (0.1%~5%)×M₀, M₀ is a coating amount of the separant, and a unit of M₀ is g/m²;
a₃ is (0.5~3)×m₀;
v is a running speed of the cold-rolled steel strip, and a unit of v is m/min;
t is a coating time for the last section, and a unit of t is min;
L₃ is a length of the last section, and a unit of L₃ is m.

In Step S5: an annealing treatment is performed on the steel coil to obtain a silicon steel.

In some embodiments, a hot stretch leveling step and an insulation coating step are further comprised after the annealing treatment is completed.

Based on a general inventive concept, according to some embodiments of the disclosure, a high-magnetic-induction grain-oriented silicon steel with excellent surface is provided, the silicon steel being prepared by the above method for preparing the high-magnetic-induction grain-oriented silicon steel with excellent surface.

The silicon steel is prepared based on the above method for preparing the high-magnetic-induction grain-oriented silicon steel with excellent surface, and steps of the method can refer to the above embodiments. The silicon steel, since adopting some or all the technical solutions of the above embodiments, has at least all the advantageous effects brought by the technical solutions of the above embodiments, which will not be repeated one by one herein.

The disclosure is further elaborated below in conjunction with specific embodiments. It should be understood that these embodiments are only used to illustrate the disclosure and not to limit a scope of the disclosure. Experimental methods without specific conditions in the following embodiments are usually determined in accordance with national standards in China. If there is no corresponding national standard in China, the experiments are carried out in accordance with general international standards, conventional conditions, or conditions recommended by a manufacturer.

### Examples 1-7 and Comparative Examples 1-5

Preparation processes of various examples and comparative examples are as follows. Smelting components of a low-temperature high-magnetic-induction grain-oriented silicon steel are: C: 0.048%, Si: 3.3%, Mn: 0.1%, S: 0.010%, Als: 0.0305%, N: 0.0069%, Sn: 0.04%, Cr: 0.08%, Cu: 0.05%, and the balance being Fe and inevitable impurity elements; a slab with a thickness of 230 mm is formed through continuous casting, is subjected to heat preservation at 1150° C. and then hot-rolled into a hot-rolled sheet with a thickness of 2.3 mm, and then normalized and cold rolled with a 20-high rolling mill to form a steel strip with a thickness of 0.23 mm, a width of 1000 mm and a length of 10000 μm; a decarburization annealing and nitriding are performed on the steel strip which is cold-rolled, a temperature of decarburization annealing being controlled at 850° C., an atmosphere dew point being controlled at a partial pressure ratio PH₂O/PH₂ of 0.50~0.60, a thickness of an oxide film being 2.8 μm, and Fe/(Si+Fe)=0.15~0.18; then the steel strip is coated with a MgO separant with a single-side coating amount M₀ of 6.5 g/m², and enters a drying furnace with a drying temperature of 300° C.; then the steel strip enters a spraying system, and a certain amount of an active agent (prepared concentration of 30%) is sprayed on a surface of the steel strip, a length L₁ of a first section being set as 100~1000 μm (a section where edge bare spots is easy to occur at a head portion), a length L₃ of a last section being set as 1000~4000 μm (a section where edge bare spots is easy to occur at a tail portion); a running speed of the steel strip is 90 μm/min, and a particle size of sprayed droplets is 10~200 μm; a coiling is performed to form a coil, followed by high-temperature annealing at a maximum temperature of 1200° C., hot stretch flatting and coating to obtain a finished product. The decarburization annealing separant adopts silicon steel grade MgO added with 5% TiO₂ and 0.2% Na₂B₄O₇. Main parameters of the preparation processes of each example and comparative example are shown in the following table:

| | | Length | Length | | | | |
|---|---|---|---|---|---|---|---|
| | | L1 of | L3 of | | set | set | set |
| | | the first | the last | Components of active | value | value | value |
| | Spraying | section, | section, | agent, mass | of a1, | of a3, | of m0, |
| | method | m | m | percentage, % | g/m² | g/m² | g/m² |
| Example 1 | Double- | 500 | 1200 | MgCl₂ | 0.005 | 0.020 | 0.009 |
| | side | | | (30%) + NaCl(70%) | | | |
| Example 2 | Double- | 600 | 3000 | NaF (10%) + CaCO₃ | 0.038 | 0.060 | 0.024 |
| | side | | | (60%) + Na₂SO₄ (30%) | | | |
| Example 3 | Double- | 1000 | 3000 | Sb₂O₃ (20%) + MgCl₂ | 0.007 | 0.056 | 0.028 |
| | side | | | (35%) + SrCl₂ (45%) | | | |
| Example 4 | Double- | 2000 | 4000 | CaCl₂ (60%) + Na₂CO₃ | 0.032 | 0.032 | 0.032 |
| | side | | | (40%) | | | |
| Example 5 | Single- | 2800 | 4000 | MgCl₂ (80%) + SbCl₃ | 0.038 | 0.065 | 0.038 |
| | side | | | (20%) | | | |
| Example 6 | Single- | 2000 | 3000 | SrCl₂ (50%) + MnCl₂ | 0.020 | 0.017 | 0.034 |
| | side | | | (20%) + CuSO₄ (30%) | | | |
| Example 7 | Single- | 700 | 2000 | CaCl₂ (70%) + Na₂CO₃ | 0.063 | 0.021 | 0.042 |
| | side | | | (30%) | | | |
| Comparative | — | — | — | — | 0 | 0 | 0 |
| Example 1 | | | | | | | |
| Comparative | Double- | 200 | 500 | CaCl₂ (60%) + Na₂CO₃ | 0.004 | 0.10 | 0.030 |
| Example 2 | side | | | (40%) | | | |
| Comparative | Double- | 300 | 4000 | CaCl₂ (60%) + MgCl₂ | 0.0045 | 0.009 | 0.0045 |
| Example 3 | side | | | (40%) | | | |
| Comparative | Single- | 500 | 6000 | CaCl₂ (50%) + Na₂CO₃ | 0.180 | 0.165 | 0.080 |
| Example 4 | side | | | (30%) + MgCl₂ (20%) | | | |
| Comparative | Single- | 1000 | 3000 | CaCl₂ (50%) + Na₂CO₃ | 0 | 0 | 0.0035 |
| Example 5 | side | | | (30%) + MgCl₂ (20%) | | | |

Implementation effects of each example and comparative example are shown in the following table:

| | Formation | | | | | |
|---|---|---|---|---|---|---|
| | state of | Bare spots length at the | | Downgrading | Magnetic | |
| | forsterite | edge of steel coil, m | | rate caused | properties | |
| | bottom | Upper | Lower | by edge | B800, | P1.7/50, |
| | layer | end | end | defects, % | T | W/kg |
| Example 1 | ◯ | <150 | <100 | <1.5 | 1.944 | 0.75 |
| Example 2 | ⊚ | <100 | <80 | <1.0 | 1.941 | 0.73 |
| Example 3 | ⊚ | <70 | <50 | <0.7 | 1.939 | 0.78 |
| Example 4 | ◯ | <60 | <50 | <0.6 | 1.930 | 0.75 |
| Example 5 | ⊚ | <80 | <50 | <0.8 | 1.926 | 0.80 |
| Example 6 | ⊚ | <100 | <60 | <1.0 | 1.935 | 0.80 |
| Example 7 | ⊚ | <110 | <70 | <1.1 | 1.937 | 0.80 |
| Comparative | X | 2300 | 1000 | 23 | 1.929 | 0.84 |
| Example 1 | | | | | | |
| Comparative | ※ | 1500 | 700 | 15 | 1.924 | 0.83 |
| Example 2 | | | | | | |
| Comparative | ¤ | 1200 | 600 | 8 | 1.927 | 0.80 |
| Example 3 | | | | | | |
| Comparative | ¤ | 1100 | 560 | 9 | 1.918 | 0.81 |
| Example 4 | | | | | | |
| Comparative | ※ | 1300 | 700 | 13 | 1.919 | 0.81 |
| Example 5 | | | | | | |

Where, in the formation state of the forsterite bottom layer, ⊚ represents that the forsterite bottom layer is uniform, bright, no color difference, excellent, with adhesion grade A and B; ◯ represents that the forsterite bottom layer is relatively uniform, bright, no bare spots, slight local color difference, with adhesion grade B and C; ¤ represents that the forsterite bottom layer is relatively uniform, slightly thin forsterite bottom layer, bare spots width at the edge <50 mm, with adhesion grade C; ※ represents that the forsterite bottom layer is uneven, color difference at the edge, bare spots width <150 mm, with adhesion grade C; x represents that the forsterite bottom layer is uneven thickness, serious color difference, bare spots width >150 mm, with adhesion grade C and D. The adhesion is determined in accordance with the national standard in China GB/T 2522 “Methods of test for the determination of coating insulation resistance and coating adhesion of electrical strip and sheet)”, and the adhesion is divided into four grades: A, B, C and D.

A calculation method of the downgrading rate caused by edge defects is: length of a section with defects such as bare spots and unevenness of the forsterite bottom layer at the edge of the steel coil/total length of the steel coil x %.

It can be seen that, with the method for preparing the high-magnetic-induction grain-oriented silicon steel with excellent surface according to some embodiments of the disclosure, for the 0.23 mm thin gauge grain-oriented silicon steel, appropriate components and amounts of the active agent are selected, and after the method is implemented, uniformity of the forsterite bottom layer on the surface of the steel strip is greatly improved, an incidence of defects such as bare spots and color difference at the edge is effectively controlled, thereby increasing a surface qualification rate and uniformity, and improving a level of magnetic property.

### Examples 8-14 and Comparative Examples 6-10

Preparation processes of each example and comparative example are as follows. Smelting components of a low-temperature high-magnetic-induction grain-oriented silicon steel are: C: 0.047%, Si: 3.2%, Mn: 0.11%, S: 0.012%, Als: 0.0304%, N: 0.0080%, Sn: 0.07%, Cr: 0.08%, Cu: 0.02%, and the balance being Fe and inevitable impurity elements; a slab with a thickness of 230 mm is formed through continuous casting, is subjected to heat preservation at 1150° C. and then hot-rolled into a hot-rolled sheet with a thickness of 2.1 mm, and then normalized and cold rolled with a twenty-high rolling mill to form a steel strip with a thickness of 0.18 mm, a width of 1000 mm and a length of 11000 μm; a decarburization annealing and nitriding are performed on the steel strip which is cold-rolled, a temperature of decarburization annealing being controlled at 850° C., an atmosphere dew point being controlled at a partial pressure ratio PH₂O/PH₂ of 0.50~0.60, a thickness of an oxide film being 3.0 μm, and Fe/(Si+Fe)=0.15~0.18; then the steel strip is coated with a MgO separant with a single-side coating amount M₀ of 6.0 g/m², and enters a drying furnace with a drying temperature of 300° C.; then the steel strip enters a spraying system, and a certain amount of an active agent (prepared concentration of 40%) is sprayed on a surface of the steel strip, a length L₁ of a first section being set as 200~1500 μm (a section where edge spot exposure is easy to occur at a head portion), and a length L₃ of a last section being set as 1000~4000 μm (a section where edge spot exposure is easy to occur at a tail portion); a running speed of the steel strip is 95 μm/min, and a particle size of sprayed droplets is 10~200 μm; a coiling is performed to form a coil, followed by high-temperature annealing at a maximum temperature of 1200° C., hot stretch flatting and coating to obtain a finished product. The decarburization annealing separant adopts silicon steel grade MgO added with 5% TiO₂ and 0.2% Na₂B₄O₇. Main parameters of the preparation processes of each example and comparative example are shown in the following table:

| | | | | | set value | set value | set value |
|---|---|---|---|---|---|---|---|
| | Spraying | Length | Length | RC components, mass | of a₁, | of a₃, | of m₀, |
| | method | L₁, m | L₃, m | percentage, % | g/m² | g/m² | g/m² |
| Example 8 | Double- | 1000 | 1500 | MgCl₂ (40%) + NaCl(60%) | 0.003 | 0.030 | 0.010 |
| | side | | | | | | |
| Example 9 | Double- | 800 | 3000 | NaF (5%) + CaCO₃ (60%) + | 0.030 | 0.060 | 0.034 |
| | side | | | Na₂SO₄ (35%) | | | |
| Example 10 | Double- | 1200 | 3000 | Sb₂O₃ (20%) + MgCl₂ | 0.007 | 0.056 | 0.028 |
| | side | | | (35%) + SrCl₂ (45%) | | | |
| Example 11 | Double- | 700 | 4000 | CaCl₂ (60%) + Na₂CO₃ | 0.035 | 0.035 | 0.035 |
| | side | | | (40%) | | | |
| Example 12 | Single- | 2500 | 4000 | MgCl₂ (80%) + SbCl₃ (20%) | 0.040 | 0.065 | 0.040 |
| | side | | | | | | |
| Example 13 | Single- | 2000 | 3000 | SrCl₂ (50%) + MnCl₂ | 0.020 | 0.017 | 0.034 |
| | side | | | (20%) + CuSO₄ (30%) | | | |
| Example 14 | Single- | 700 | 4100 | CaCl₂ (70%) + Na₂CO₃ | 0.060 | 0.020 | 0.040 |
| | side | | | (30%) | | | |
| Comparative | — | — | — | — | 0 | 0 | 0 |
| Example 6 | | | | | | | |
| Comparative | Double- | 400 | 800 | CaCl₂ (60%) + Na₂CO₃ | 0.004 | 0.10 | 0.030 |
| Example 7 | side | | | (40%) | | | |
| Comparative | Double- | 300 | 4000 | CaCl₂ (60%) + MgCl₂ (40%) | 0.0050 | 0.009 | 0.0045 |
| Example 8 | side | | | | | | |
| Comparative | Single- | 500 | 6000 | CaCl₂ (50%) + Na₂CO₃ | 0.190 | 0.160 | 0.080 |
| Example 9 | side | | | (30%) + MgCl₂ (20%) | | | |
| Comparative | Single- | 1000 | 3000 | CaCl₂ (50%) + Na₂CO₃ | 0 | 0 | 0.0035 |
| Example 10 | side | | | (30%) + MgCl₂ (20%) | | | |

Implementation effects of each example and comparative example are shown in the following table.

| | Formation | | | | | |
|---|---|---|---|---|---|---|
| | state of | Bare spots length at the | | Downgrading | Magnetic | |
| | forsterite | edge of steel coil, m | | rate caused | properties | |
| | bottom | Upper | Lower | by edge | B800, | P1.7/50, |
| | layer | end | end | defects, % | T | W/kg |
| Example 8 | ◯ | <160 | <100 | <1.6 | 1.938 | 0.67 |
| Example 9 | ⊚ | <120 | <80 | <1.2 | 1.931 | 0.70 |
| Example 10 | ⊚ | <80 | <60 | <0.8 | 1.933 | 0.68 |
| Example 11 | ◯ | <100 | <50 | <1.0 | 1.932 | 0.67 |
| Example 12 | ⊚ | <70 | <50 | <0.7 | 1.936 | 0.66 |
| Example 13 | ⊚ | <90 | <60 | <0.9 | 1.932 | 0.63 |
| Example 14 | ⊚ | <100 | <70 | <1.0 | 1.937 | 0.65 |
| Comparative | X | 2300 | 1000 | 23 | 1.919 | 0.73 |
| Example 6 | | | | | | |
| Comparative | ※ | 1500 | 700 | 15 | 1.928 | 0.71 |
| Example 7 | | | | | | |
| Comparative | ¤ | 1200 | 600 | 9 | 1.932 | 0.74 |
| Example 8 | | | | | | |
| Comparative | ¤ | 1100 | 560 | 8 | 1.924 | 0.69 |
| Example 9 | | | | | | |
| Comparative | ※ | 1300 | 700 | 13 | 1.929 | 0.73 |
| Example 10 | | | | | | |

Where, in the formation state of the forsterite bottom layer, ⊚ represents that the forsterite bottom layer is uniform, bright, no color difference, excellent, with adhesion grade A and B; ◯ represents that the forsterite bottom layer is relatively uniform, bright, no bare spots, slight local color difference, with adhesion grade B and C; ¤ represents that the forsterite bottom layer is relatively uniform, slightly thin forsterite bottom layer, bare spots width at the edge <50 mm, with adhesion grade C; ※ represents that the forsterite bottom layer is uneven, color difference at the edge, bare spots width <150 mm, with adhesion grade C; x represents that the forsterite bottom layer is uneven thickness, serious color difference, bare spots width >150 mm, with adhesion grade C and D. The adhesion is determined in accordance with the national standard in China GB/T 2522 “Test Methods for Surface Insulation Resistance and Coating Adhesion of Electrical Steel Sheets (Strips)”, and the adhesion is divided into four grades: A, B, C and D.

A calculation method of the downgrading rate caused by edge defects is: length of a section with defects such as bare spots and unevenness of the forsterite bottom layer at the edge of the steel coil/total length of the steel coil x %.

It can be seen that, for the 0.18 mm ultra-thin gauge grain-oriented silicon steel, after implementation of the method for preparing the high-magnetic-induction grain-oriented silicon steel with excellent surface according to some embodiments of the disclosure by selecting appropriate components and amounts of the active agent, uniformity of the forsterite bottom layer on the surface of the steel strip is greatly improved, an incidence of defects such as bare spots and color difference at the edge is effectively controlled, a surface qualification rate is improved, and a level of magnetic property is also improved.

Compared with the related art, the method for preparing the high-magnetic-induction grain-oriented silicon steel with excellent surface according to some embodiments of the disclosure has the following advantages:

According to the method for preparing the high-magnetic-induction grain-oriented silicon steel with excellent surface according to some embodiments of the disclosure, by coating the surface of the cold-rolled steel strip with an active agent after coating the separant, a forsterite layer forming reaction of the cold-rolled steel strip can be promoted. Meanwhile, a liquid or gaseous substance is formed between layers of the steel coil during a subsequent annealing treatment to accelerate mass transfer, promoting a formation reaction of the forsterite bottom layer locally on the steel coil, and thus a problem of surface brae spot defects caused by poor reaction capacity at a head portion and a tail portion due to uneven heating during high-temperature annealing of thin gauge products at present can be solved; and a problem of uneven forsterite bottom layer quality caused by defects such as bare spots at the edge of the steel coil, a thin forsterite bottom layer and a color difference existing in production of thin gauge silicon steel by a conventional process at present can be solved.

Various embodiments of the disclosure may exist in a form of a range; it should be understood that the description in the form of a range is only for convenience and conciseness, and should not be construed as a rigid limitation on the scope of the disclosure; therefore, the description of the range should be deemed to have specifically disclosed all possible subranges and individual numerical values within the range. For example, the description of a range from 1 to 6 should be deemed to have specifically disclosed subranges such as from 1 to 3, from 1 to 4, from 1 to 5, from 2 to 4, from 2 to 6, from 3 to 6, etc., as well as individual numbers within the range, such as 1, 2, 3, 4, 5 and 6, which applies regardless of the range. In addition, whenever a numerical range is indicated herein, it is meant to comprise any cited number (fraction or integer) within the indicated range.

In the disclosure, unless otherwise stated, directional terms such as “upper” and “lower” specifically refer to a direction of a drawing plane in the drawings. In addition, in the description of the present specification, the terms “comprise”, “include” and the like mean “comprising but not limited to”. In this document, relational terms such as “first” and “second” are only used to distinguish one entity or operation from another entity or operation, and do not necessarily require or imply any such actual relationship or order between these entities or operations. In this document, “and/or” describes an association relationship of associated objects, indicating that three relationships may exist, for example, A and/or B may represent: A exists alone, both A and B exist, and B exists alone. Where A and B may be singular or plural. Herein, “at least one” means one or more, and “a plurality of” means two or more. “At least one kind”, “at least one of the following items” or similar expressions refer to any combination of these items, comprising any combination of a single item or a plurality of items. For example, “at least one of a, b, or c”, or “at least one of a, b, and c”, may each represent: a, b, c, a-b (i.e., a and b), a-c, b-c, or a-b-c, where a, b, c may each be single or multiple.

The above are only specific embodiments of the disclosure, enabling those skilled in the art to understand or implement the disclosure. Various modifications to these embodiments will be obvious to those skilled in the art, and the general principles defined herein can be implemented in other embodiments without departing from the spirit or scope of the disclosure. Therefore, the disclosure will not be limited to the embodiments shown herein, but will conform to the widest scope consistent with the principles and novel features applied for herein.

What is claimed is:

1. A method for preparing a high-magnetic-induction grain-oriented silicon steel with excellent surface, comprising:
obtaining a cold-rolled steel strip;
performing a decarburization annealing and nitriding treatment on the cold-rolled steel strip to form an oxide film on a surface of the cold-rolled steel strip;
coating the cold-rolled steel strip subjected to the decarburization annealing and nitriding treatment, with a separant;
drying the cold-rolled steel strip coated with the separant and coating the same with an active agent, followed by coiling to obtain a steel coil, a component of the active agent comprising a low-melting-point compound with a melting point ≤900° C.; and
performing an annealing treatment on the steel coil to obtain a silicon steel.

2. The method for preparing the high-magnetic-induction grain-oriented silicon steel with excellent surface according to claim 1, wherein the low-melting-point compound comprises at least one of oxides of reactive metals, fluorides of reactive metals, chlorides of reactive metals, carbonates of reactive metals and sulfates of reactive metals, the reactive metal comprising at least one of Sr, Sb, Na, Mg, Zn, Ba, and Ca.

3. The method for preparing the high-magnetic-induction grain-oriented silicon steel with excellent surface according to claim 1, wherein a weight concentration of the low-melting-point compound in the active agent is 10%~50%.

4. The method for preparing the high-magnetic-induction grain-oriented silicon steel with excellent surface according to claim 1, wherein after coating of the active agent is completed, a period during which a surface temperature of the cold-rolled steel strip is ≥150° C. at least exists, to dry the active agent; and/or
the coating of the active agent is a single-side coating or a double-side coating; and/or
a coating manner of the active agent is spraying, with a droplet diameter of 10~300 μm.

5. The method for preparing the high-magnetic-induction grain-oriented silicon steel with excellent surface according to claim 1, wherein the cold-rolled steel strip comprises a first section, a middle section and a last section, a relationship of a length L₁ of the first section, a length L₂ of the middle section, a length L₃ of the last section and a total length L of the entire cold-rolled steel strip satisfying: L=L₁+L₂+L₃, relationships among an active agent coating amount m₁ of the first section, an active agent coating amount m₂ of the middle section and an active agent coating amount m₃ of the last section respectively satisfying: m₁≥m₂ and m₃≥m₂.

6. The method for preparing the high-magnetic-induction grain-oriented silicon steel with excellent surface according to claim 5, wherein a calculation formula of the active agent coating amount m₁ of the first section is:
$${m}_{1} = {a}_{1} ( 1 - \frac{vt}{{L}_{1}} ) + {m}_{0} ,$$
where m₀ is (0.1%~5%)×M₀, M₀ is a coating amount of the separant, and a unit of M₀ is g/m²;
a₁ is (0.2~1.5)×m₀;
v is a running speed of the cold-rolled steel strip, and a unit of v is m/min;
t is a coating time for the first section, and a unit of t is min;
L₁ is a length of the first section, and a unit of L₁ is m;
a calculation formula for the active agent coating amount m₂ of the middle section is:
m₂=m₀, where m₀ is (0.1%~5%)×M₀, M₀ is a coating amount of the separant, and a unit of M₀ is g/m²;
a calculation formula for the active agent coating amount m₃ of the last section is:
$${m}_{3} = {a}_{3} \cdot \frac{vt}{{L}_{3}} + {m}_{0} ,$$
where m₀ is (0.1%~5%)×M₀, M₀ is a coating amount of the separant, and a unit of M₀ is g/m²;
a₃ is (0.5~3)×m₀;
v is a running speed of the cold-rolled steel strip, and a unit of v is m/min;
t is a coating time for the last section, and a unit of t is min;
L₃ is a length of the last section, and a unit of L₃ is m.

7. The method for preparing the high-magnetic-induction grain-oriented silicon steel with excellent surface according to claim 6, wherein m₀ is a set reference amount of the active agent, and a unit of m₀ is g/m².

8. The method for preparing the high-magnetic-induction grain-oriented silicon steel with excellent surface according to claim 5, wherein a relationship between the length L₁ of the first section and the total length L of the entire cold-rolled steel strip satisfies: L₁=0.05L~0.3L; a relationship between the length L₃ of the last section and the total length L of the entire cold-rolled steel strip satisfies: L₃=0.1L~0.4L.

9. The method for preparing the high-magnetic-induction grain-oriented silicon steel with excellent surface according to claim 6, wherein a relationship between the length L₁ of the first section and the total length L of the entire cold-rolled steel strip satisfies: L₁=0.05L~0.3L;
a relationship between the length L₃ of the last section and the total length L of the entire cold-rolled steel strip satisfies: L₃=0.1L~0.4L.

10. The method for preparing the high-magnetic-induction grain-oriented silicon steel with excellent surface according to claim 1, wherein a thickness of the oxide film is 2.0~3.5 m; and/or
an atomic weight ratio of Si element and Fe element in the oxide film satisfies: Fe/(Si+Fe)=0.08~0.25.

11. The method for preparing the high-magnetic-induction grain-oriented silicon steel with excellent surface according to claim 1, wherein components of the cold-rolled steel strip comprise, by weight fraction: C: 0.04%~0.08%; Si: 3.0%~4.0%; Mn: 0.03%~0.22%; S: 0.005%~0.020%; Als: 0.0235%~0.0345%; N: 0.0050%~0.0130%; Sn: 0.01%~0.15%; Cr: 0.03%~0.4%; Cu: 0.01%~0.8%; and the balance being Fe and inevitable impurities.

12. A high-magnetic-induction grain-oriented silicon steel with excellent surface, wherein the silicon steel is prepared by a method comprising:
obtaining a cold-rolled steel strip;
performing a decarburization annealing and nitriding treatment on the cold-rolled steel strip to form an oxide film on a surface of the cold-rolled steel strip;
coating the cold-rolled steel strip subjected to the decarburization annealing and nitriding treatment, with a separant;
drying the cold-rolled steel strip coated with the separant and coating the same with an active agent, followed by coiling to obtain a steel coil, a component of the active agent comprising a low-melting-point compound with a melting point ≤900° C.; and
performing an annealing treatment on the steel coil to obtain the silicon steel.

13. The high-magnetic-induction grain-oriented silicon steel with excellent surface according to claim 12, wherein the low-melting-point compound comprises at least one of oxides of reactive metals, fluorides of reactive metals, chlorides of reactive metals, carbonates of reactive metals and sulfates of reactive metals, the reactive metal comprising at least one of Sr, Sb, Na, Mg, Zn, Ba, and Ca.

14. The high-magnetic-induction grain-oriented silicon steel with excellent surface according to claim 12, wherein a weight concentration of the low-melting-point compound in the active agent is 10%~50%.

15. The high-magnetic-induction grain-oriented silicon steel with excellent surface according to claim 12, wherein after coating of the active agent is completed, a period during which a surface temperature of the cold-rolled steel strip is ≥150° C. at least exists, to dry the active agent; and/or
the coating of the active agent is a single-side coating or a double-side coating; and/or
a coating manner of the active agent is spraying, with a droplet diameter of 10~300 μm.

16. The high-magnetic-induction grain-oriented silicon steel with excellent surface according to claim 12, wherein the cold-rolled steel strip comprises a first section, a middle section and a last section, a relationship of a length L₁ of the first section, a length L₂ of the middle section, a length L₃ of the last section and a total length L of the entire cold-rolled steel strip satisfying: L=L₁+L₂+L₃, relationships among an active agent coating amount m₁ of the first section, an active agent coating amount m₂ of the middle section and an active agent coating amount m₃ of the last section respectively satisfying: m₁≥m₂ and m₃≥m₂.

17. The high-magnetic-induction grain-oriented silicon steel with excellent surface according to claim 16, wherein a calculation formula of the active agent coating amount m₁ of the first section is:
$${m}_{1} = {a}_{1} ( 1 - \frac{vt}{{L}_{1}} ) + {m}_{0} ,$$
where m₀ is (0.1%~5%)×M₀, M₀ is a coating amount of the separant, and a unit of M₀ is g/m²;
a₁ is (0.2~1.5)×m₀;
v is a running speed of the cold-rolled steel strip, and a unit of v is m/min;
t is a coating time for the first section, and a unit of t is min;
L₁ is a length of the first section, and a unit of L₁ is m;
a calculation formula for the active agent coating amount m₂ of the middle section is:
m₂=m₀, where m₀ is (0.1%~5%)×M₀, M₀ is a coating amount of the separant, and a unit of M₀ is g/m²;
a calculation formula for the active agent coating amount m₃ of the last section is:
$${m}_{3} = {a}_{3} \cdot \frac{vt}{{L}_{3}} + {m}_{0} ,$$
where m₀ is (0.1%~5%)×M₀, M₀ is a coating amount of the separant, and a unit of M₀ is g/m²;
a₃ is (0.5~3)×m₀;
v is a running speed of the cold-rolled steel strip, and a unit of v is m/min;
t is a coating time for the last section, and a unit of t is min;
L₃ is a length of the last section, and a unit of L₃ is m.

18. The high-magnetic-induction grain-oriented silicon steel with excellent surface according to claim 17, wherein m₀ is a set reference amount of the active agent, and a unit of m₀ is g/m².

19. The high-magnetic-induction grain-oriented silicon steel with excellent surface according to claim 16, wherein a relationship between the length L₁ of the first section and the total length L of the entire cold-rolled steel strip satisfies: L₁=0.05L~0.3L; a relationship between the length L₃ of the last section and the total length L of the entire cold-rolled steel strip satisfies: L₃=0.1L~0.4L.

20. The high-magnetic-induction grain-oriented silicon steel with excellent surface according to claim 17, wherein a relationship between the length L₁ of the first section and the total length L of the entire cold-rolled steel strip satisfies: L₁=0.05L~0.3L; a relationship between the length L₃ of the last section and the total length L of the entire cold-rolled steel strip satisfies: L₃=0.1L~0.4L.
